(19) United States
(12) Patent Application Publication
(10) Pub. No.: US 2026/0203107 A1
(43) Pub. Date: Jul. 16, 2026

(54) PARALLEL PROCESSING APPARATUS FOR SINGLE-THREADED PROGRAM

(71) Applicant: TAIZHOU ASKPOWER ELECTRONICS CO., LTD., Taizhou (CN)

(72) Inventor: Zuojin WU, Taizhou (CN)

(21) Appl. No.: 19/563,011

(22) Filed: Mar. 11, 2026

Related U.S. Application Data
(63) Continuation of application No. PCT/CN2024/106719, filed on Jul. 22, 2024.

(30) Foreign Application Priority Data
Aug. 15, 2023 (CN) 202311027093.2
Jul. 16, 2024 (CN) 202410952716.5

(51) Int. Cl. G06F 9/48

(52) U.S. Cl. CPC G06F 9/4881

(57) ABSTRACT

Provided is a single-thread-program parallel processing apparatus, comprising a storage module (1), an identification module (2), a control module (3), and operation modules (4). The storage module (1) is used for storing code segments; the identification module (2) is used for identifying a plurality of code segments on the basis of markers that mark the code segments, wherein the plurality of code segments are used for being executed in parallel; there are N operation modules (4); and the control module (3) is used for controlling all the operation modules (4) to execute the plurality of code segments in a parallel processing manner.

### CROSS-REFERENCE TO RELATED APPLICATIONS

This application is a continuation of International Patent Application No. PCT/CN2024/106719, filed July 22, 2024, and claims priority of Chinese Patent Application No. 202311027093.2, filed on August 15, 2023, and Chinese Patent Application No. 202410952716.5, filed on July 16, 2024. The entire contents of International Patent Application No. PCT/CN2024/106719, Chinese Patent Application No. 202311027093.2, and Chinese Patent Application No. 202410952716.5 are incorporated herein by reference.

### TECHNICAL FIELD

The present application relates to the field of processors, and in particular, to a parallel processing apparatus for a single-threaded program.

### BACKGROUND

Single-threaded programs are characterized by high system stability and strong scalability.

However, during the execution of a single-threaded program, the program path followed follows a sequential order, where preceding processes must be completed before subsequent ones can be executed.

This results in longer operation times for single-threaded programs.

### SUMMARY

To reduce program operation time, the present application provides a parallel processing apparatus for a single-threaded program.

The present application provides a parallel processing apparatus for a single-threaded program, adopting the following technical solution:

a parallel processing apparatus for a single-threaded program, comprising: a storage module, an identification module, a control module, and operation modules;

the storage module is configured to store code segments;

the identification module is configured to identify a plurality of code segments based on markers tagging the code segments, wherein the plurality of code segments are to be executed in parallel;

N operation modules are provided; and

the control module is configured to control all of the operation modules to execute the plurality of code segments in a parallel processing manner.

By adopting the above technical solution, the source code of a single-threaded program is pre-compiled into executable code, and the executable code is tagged to obtain a plurality of code segments that can be executed in parallel. The plurality of code segments are stored in the storage module, and the operation modules execute the plurality of code segments in a parallel processing manner, thereby achieving parallel processing of the single-threaded program, which is beneficial for improving the operation speed of the single-threaded program and reducing program operation time.

Preferably, the control module being configured to control all of the operation modules to execute the plurality of code segments in a parallel processing manner comprises:

the operation modules are configured to output an indicator upon completing execution of a code segment; and

the control module is configured to, upon detecting N indicators, control all of the operation modules to execute the next group of N code segments in a parallel processing manner.

By adopting the above technical solution, whether the current code segments are completed is determined by the indicators, thereby controlling the execution of subsequent code segments; after completing the parallel processing of N code segments, the next group of N code segments is then executed in parallel.

Preferably, the control module being configured to control all of the operation modules to execute the plurality of code segments in a parallel processing manner comprises:

the control module is configured to determine status of all of the operation modules; and

the control module is configured to control an idle operation module to execute a specific code segment, wherein the specific code segment is any one executable code segment among all code segments to be executed.

By adopting the above technical solution, the time required for different operation modules to execute different code segments may vary. When any operation module becomes idle, that idle operation module immediately executes a subsequent code segment, reducing program operation time.

Preferably, the control module is configured to determine whether a code segment is executable based on code segment execution conditions.

By adopting the above technical solution, it enables controlling an idle operation module to execute a specific code segment.

In summary, the present application includes at least the following beneficial technical effects:

The source code of a single-threaded program is pre-compiled into executable code, and the executable code is tagged to obtain a plurality of code segments that can be executed in parallel. The plurality of code segments are stored in the storage module, and the operation modules execute the plurality of code segments in a parallel processing manner, thereby achieving parallel processing of the single-threaded program, which is beneficial for improving the operation speed of the single-threaded program and reducing program operation time;

Whether the current code segments are completed is determined by the indicators, thereby controlling the execution of subsequent code segments;

During the parallel execution of multiple code segments, after completing the parallel processing of N code segments, the next group of N code segments is then executed in parallel;

The time required for different operation modules to execute different code segments may vary. When any operation module becomes idle, that idle operation module immediately executes a subsequent code segment, reducing program operation time.

### BRIEF DESCRIPTION OF THE DRAWINGS

FIG. 1 is a structural block diagram of the parallel processing apparatus for a single-threaded program.

### LIST OF REFERENCE SIGNS

1, Storage module; 2, Identification module; 3, Control module; 4, Operation module.

### DETAILED DESCRIPTION

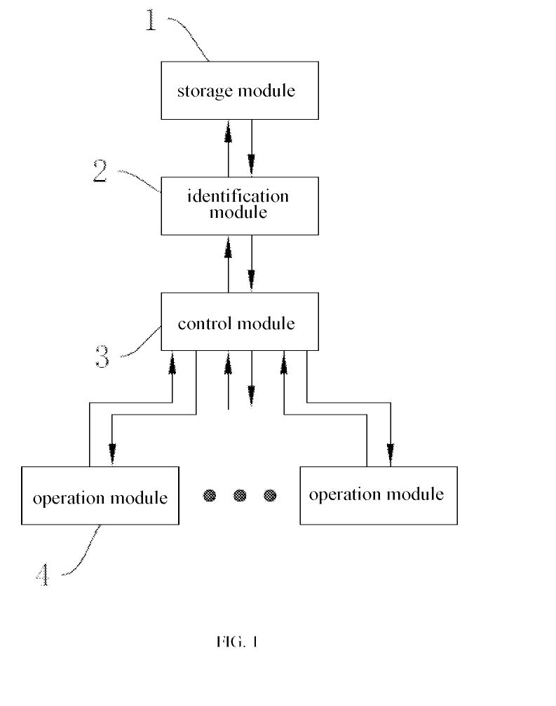

The present application will be further described in detail below with reference to FIG. 1.

### Embodiment 1

The embodiment of the present application discloses a parallel processing method for a single-threaded program, comprising the following steps.

A parallel processing apparatus for a single-threaded program comprises a storage module 1, an identification module 2, a control module 3, and operation modules 4.

The storage module 1 is configured to store the code segments obtained by the above method.

The identification module 2 is configured to identify a plurality of code segments based on markers tagging the code segments.

N operation modules 4 are provided.

The control module 3 is configured to control all operation modules 4 to execute the plurality of code segments in a parallel processing manner.

Specifically, the control module 3 is configured to control all operation modules 4 to execute N code segments in a parallel processing manner;

the operation modules 4 are configured to output an indicator upon completing execution of a code segment; and

the control module 3 is configured to, upon detecting N indicators, control all operation modules 4 to execute the next group of N code segments in a parallel processing manner.

### Embodiment 2

The difference between this embodiment and Embodiment 1 lies in that the control module 3 being configured to control all operation modules 4 to execute the plurality of code segments in a parallel processing manner comprises:

The control module 3 is configured to control all operation modules 4 to execute N code segments in a parallel processing manner;

The control module 3 is configured to determine the status of all operation modules 4;

The control module 3 is configured to control an idle operation module 4 to execute a specific code segment, wherein the specific code segment is any one executable code segment among all code segments to be executed.

Specifically, the operation modules 4 are configured to output an indicator upon completing execution of a code segment;

The control module 3 is configured to determine the status of the operation modules 4 based on the indicator;

The control module 3 is configured to determine whether a code segment is executable based on code segment execution conditions; the code segment execution conditions include dependencies, causal relationships, data relationships, etc., with respect to code segments currently being executed.

### Embodiment 3

The difference between this embodiment and Embodiment 1 lies in that the control module 3 being configured to control all operation modules 4 to execute the plurality of code segments in a parallel processing manner comprises:

the control module 3 is configured to control all operation modules 4 to execute N code segments in a parallel processing manner;

the operation modules 4 are configured to output an indicator upon completing execution of a code segment;

the control module 3 is configured to determine the status of all operation modules 4;

the control module 3 is configured to, upon detecting M indicators, control an idle operation module 4 to execute a specific code segment; wherein 1 ≤ M < N, and the specific code segment is any executable code segment among all code segments to be executed;

the control module 3 is configured to, upon detecting N indicators, control all operation modules 4 to execute the next group of N specific code segments in a parallel processing manner.

The control module 3 is configured to determine whether a code segment is executable based on code segment execution conditions; the code segment execution conditions include dependencies, causal relationships, data relationships, etc., with respect to code segments currently being executed.

Implementation principle of the parallel processing apparatus for a single-threaded program according to the embodiments of the present application: The source code of a single-threaded program is pre-compiled into executable code, and the executable code is tagged to obtain a plurality of code segments that can be executed in parallel. The plurality of code segments are stored in the storage module 1, and the operation modules 4 execute the plurality of code segments in a parallel processing manner, thereby achieving parallel processing of the single-threaded program, which is beneficial for improving the operation speed of the single-threaded program and reducing program operation time.

The above are only preferred embodiments of the present application and are not intended to limit the protection scope of the present application. Therefore, any equivalent changes made based on the structure, shape, or principles of the present application shall fall within the protection scope of the present application.

1. A parallel processing apparatus for a single-threaded program, comprising: a storage module, an identification module, a control module, and operation modules;
the storage module is configured to store code segments;
the identification module is configured to identify a plurality of code segments based on markers tagging the code segments, wherein the plurality of code segments are to be executed in parallel;
N of the operation modules are provided; and
the control module is configured to control all of the operation modules to execute the plurality of code segments in a parallel processing manner.

2. The parallel processing apparatus for a single-threaded program according to claim 1, wherein the control module being configured to control all of the operation modules to execute the plurality of code segments in the parallel processing manner comprises:
the operation modules are configured to output an indicator upon completing execution of a code segment of the plurality of code segments; and
the control module is configured to, upon detecting N of the indicators, control all of the operation modules to execute a next group of N code segments in the parallel processing manner.

3. The parallel processing apparatus for a single-threaded program according to claim 1, wherein the control module being configured to control all of the operation modules to execute the plurality of code segments in the parallel processing manner comprises:
the control module is configured to determine status of all of the operation modules; and
the control module is configured to control an idle operation module to execute a specific code segment of the plurality of code segments, wherein the specific code segment is any one executable code segment among all of the plurality of code segments to be executed.

4. The parallel processing apparatus for a single-threaded program according to claim 3, wherein the control module is configured to determine whether a code segment of the plurality of code segments is executable based on code segment execution conditions.
